(19) United States
(12) Patent Application Publication
(10) Pub. No.: US 2026/0253148 A1
(43) Pub. Date: Aug. 27, 2026

(54) ENERGY MANAGEMENT SYSTEM, ENERGY MANAGEMENT METHOD, AND ENERGY MANAGEMENT PROGRAM

(71) Applicant: Yokogawa Electric Corporation, Tokyo (JP)

(72) Inventors: Tomohiro KURODA, Tokyo (JP); Hironori HAYASHIZAKI, Tokyo (JP); Akari HARA, Tokyo (JP)

(21) Appl. No.: 19/163,513

(22) PCT Filed: Mar. 14, 2024
(86) PCT No.: PCT/JP2024/010004

§ 371 Date: Sep. 9, 2025

(30) Foreign Application Priority Data
Mar. 14, 2023 (JP) 2023-039954

(51) Int. Cl. G06Q 50/06; H02J 13/12

(52) U.S. Cl. CPC G06Q 50/06; H02J 13/12

(57) ABSTRACT

An energy management system 1 includes a first reception unit configured to receive an amount of clean energy obtained, a second reception unit configured to receive an amount of energy used, a third reception unit configured to receive a setting of a degree of priority for an allocated target where the amount of clean energy obtained is to be allocated, and a determination unit configured to determine, by comparing the amount of clean energy obtained with the amount of energy used at the allocated target, an amount of clean energy allocated to the allocated target on the basis of the degree of priority.

### TECHNICAL FIELD

The present invention relates to an energy management system, an energy management method, and an energy management program.

### BACKGROUND ART

With the increase in the attention drawn to the international initiative, so-called 100% Renewable Energy (RE100), which is aimed at use of renewable energy by corporations for 100% of electric power used in operations of the corporations, the importance of electric power tracking to certify the derivation of power generation sources is increasing.

The following conventional techniques have been proposed in relation to such electric power tracking. For example, a power transaction platform that has been proposed evaluates and certifies fair environmental values of electric power distributed in power transactions related to reusable energy in accordance with when, where, by whom, and by what power generation systems the electric power has been generated. Furthermore, an energy management apparatus that has been proposed calculates product intensities, such as amounts of electric power consumed and fuels that are needed for production of certain quantities of products, for different product identifications (IDs) by using an existing tracking system.

### CITATION LIST

### Patent Literature

PTL 1: Japanese Laid-open Patent Publication No. 2022-151174
PTL 2: Japanese Laid-open Patent Publication No. 2022-092898

### SUMMARY OF INVENTION

### Technical Problem

However, the above mentioned conventional techniques have room for improvement with respect to evaluation of the level of consumption of electric power derived from clean energy including renewable energy, the evaluation being in smaller units than that in evaluation in units of overall organizations, the smaller units being, for example, units of products or units of manufacturing processes.

For example, the above mentioned power transaction platform does not enable evaluation of levels of clean energy in units smaller than units of overall organizations because the power transaction platform only implements measurement of amounts of power generated or consumed and calculation of electric power values and environmental values, the measurement and calculation being performed in units of overall organizations called users. Furthermore, the above mentioned energy management apparatus only calculates energy consumption for each product and is unable to calculate the level of consumption of electric power derived from clean energy in units of products.

An object of the present invention is to implement evaluation of levels of clean energy in units smaller than units of overall organizations.

### Solution to Problem

According to one aspect of embodiments, an energy management system includes: a first reception unit configured to receive an amount of clean energy obtained; a second reception unit configured to receive an amount of energy used; a third reception unit configured to receive a setting of a degree of priority for an allocated target where the amount of clean energy obtained is to be allocated; and a determination unit configured to determine, by comparing the amount of clean energy obtained with the amount of energy used at the allocated target, an amount of clean energy allocated to the allocated target on the basis of the degree of priority.

According to one aspect of embodiments, an energy management method carried out by a computer, includes: receiving an amount of clean energy obtained; receiving an amount of energy used; receiving a setting of a degree of priority for an allocated target where the amount of clean energy obtained is to be allocated; and determining, by comparing the amount of clean energy obtained with the amount of energy used at the allocated target, an amount of clean energy allocated to the allocated target on the basis of the degree of priority.

According to one aspect of embodiments, an energy management program causes a computer to execute a process including: receiving an amount of clean energy obtained; receiving an amount of energy used; receiving a setting of a degree of priority for an allocated target where the amount of clean energy obtained is to be allocated; and determining, by comparing the amount of clean energy obtained with the amount of energy used at the allocated target, an amount of clean energy allocated to the allocated target on the basis of the degree of priority.

### Advantageous Effects of Invention

One embodiment enables evaluation of levels of clean energy in units smaller than units of overall organizations.

### BRIEF DESCRIPTION OF DRAWINGS

FIG. 1 is a diagram illustrating an example of a configuration of an energy management system.

FIG. 2 is a flowchart illustrating steps of a data reception process.

FIG. 3 is a schematic diagram illustrating an electric power supply system.

FIG. 4 is a schematic diagram illustrating an example of purchase of a certificate.

FIG. 5 is a flowchart illustrating steps of an energy allocation process.

FIG. 6 is a flowchart illustrating steps of an RE level calculation process.

FIG. 7 is a diagram illustrating an example of display on a user terminal.

FIG. 8 is a diagram illustrating an example of display on the user terminal.

FIG. 9 is a diagram illustrating an example of a hardware configuration.

### DESCRIPTION OF EMBODIMENTS

Embodiments of an energy management system, an energy management method, and an energy management program according to the present application will hereinafter be described by reference to the appended drawings. Each of the embodiments merely illustrates an example or aspect, and scope of numerical values and functions and scenes of use are not to be limited by such illustration. The embodiments may be combined, as appropriate, so long as no contradictions in their processing are caused by the combination.

### First Embodiment

### Overall Configuration

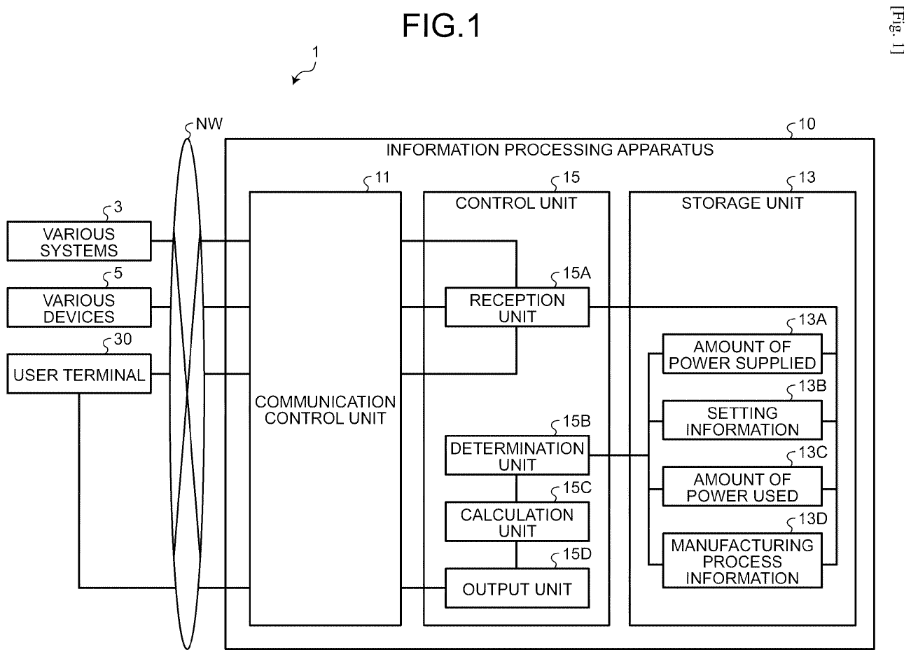

An overall configuration of an energy management system 1 according to an embodiment will be described first. FIG. 1 is a diagram illustrating an example of the configuration of the energy management system 1. The energy management system 1 illustrated in FIG. 1 provides, in electric power tracking, an allocation function of allocating part of clean energy supplied to an organization as a whole according to an amount of energy used at a target smaller than the organization, the target being, for example, a product or a manufacturing process.

A “target” referred to herein corresponds to an example of a target, to which energy is allocated, and examples thereof may include a product, a manufacturing process, a manufacturing line, and a manufacturing plant. The examples are not limited to targets related to manufacturing and may include demand facilities included in offices, for example. Such targets may hereinafter be collectively referred to as “allocated targets”.

Furthermore, “energy” may include clean energy and non-clean energy. This “clean energy” is also called green energy and may include, for example, so-called renewable energy. Furthermore, “non-clean energy” refers to energy that is not clean energy and may include, for example, fossil energy. Renewable energy will hereinafter be mentioned as an example of clean energy and this renewable energy may hereinafter be referred to as “RE”.

As illustrated in FIG. 1, the energy management system 1 may include various systems 3, various devices 5, an information processing apparatus 10, and a user terminal 30. These various system 3, various devices 5, and user terminal 30 may be communicably connected to the information processing apparatus 10 via any network NW. The network NW may be wired or wireless and may be implemented by any technology, such as Internet technology, industrial communication standards, or power saving wireless communication standards for Internet of Things (IoT).

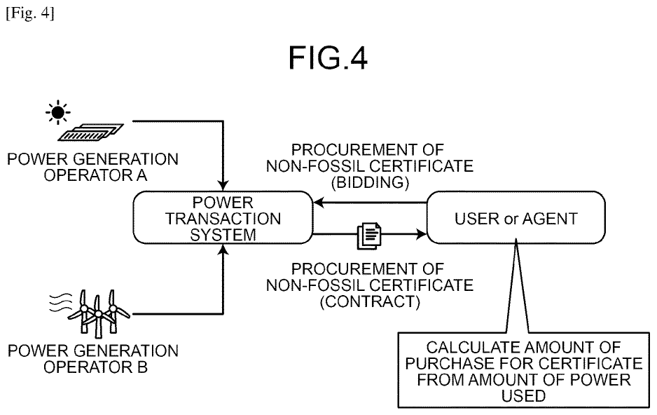

The various systems 3 are various systems that may be connected to the information processing apparatus 10. For example, the various systems 3 may include a power transaction system for transactions of environmental values, such as green power certificates, J-Credits, and non-fossil certificates. The power transaction system will be described later by use of FIG. 4. The various systems 3 may also include a manufacture management system used by a user who receives provision of the above mentioned allocation function.

The various devices 5 are various devices that may be connected to the information processing apparatus 10. For example, the various devices 5 may include a smart meter that measures amounts of power used by a demand facility that a user has, the user being a user who receives provision of the above mentioned allocation function. Such demand facilities may include, in addition to manufacturing lines that are facilities of manufacturing plants and manufacturing apparatuses included in the manufacturing lines, office facilities.

The information processing apparatus 10 is an example of a computer that provides the above mentioned allocation function. For example, the information processing apparatus 10 may be implemented as a server that provides the above mentioned allocation function on premises. The information processing apparatus 10 may also provide the above mentioned allocation function as a cloud service by being implemented as a Platform as a Service (PaaS) application or a Software as a Service (SaaS) application.

The user terminal 30 is a terminal device used by a user who receives provision of the above mentioned allocation function. A “user” referred to herein may be, for example, not only an organization, such as a corporation, but a party concerned with the organization. For example, the user terminal 30 may be implemented by a personal computer, or any computer, such as a smartphone, a tablet device, or a wearable device.

### Configuration of Information Processing Apparatus 10

An example of a functional configuration of the information processing apparatus 10 according to the embodiment will be described next. FIG. 1 schematically illustrates blocks related to the allocation function that the information processing apparatus 10 has. As illustrated in FIG. 1, the information processing apparatus 10 has a communication control unit 11, a storage unit 13, and a control unit 15. FIG. 1 just selectively illustrates functional units related to the above mentioned allocation function and the information processing apparatus 10 may thus include any other functional unit not illustrated therein.

The communication control unit 11 is a functional unit that controls communication between: the information processing apparatus 10; and the various systems 3 and other devices, such as, the various devices 5, and the user terminal 30. For example, the communication control unit 11 may be implemented by a network interface card.

The storage unit 13 is a functional unit that stores various types of data. For example, the storage unit 13 may be implemented by an internal, external, or auxiliary storage of the information processing apparatus 10. For example, the storage unit 13 stores data, such as amounts of power supplied 13A, setting information 13B, amounts of power used 13C, and manufacturing process information 13D. The data, such as the amounts of power supplied 13A, the setting information 13B, the amounts of power used 13C, and the manufacturing process information 13D, will be described when a scene where referencing, generation, or registration is executed is described later.

The control unit 15 is a functional unit that performs overall control of the information processing apparatus 10. For example, the control unit 15 may be implemented by a hardware processor. As illustrated in FIG. 1, the control unit 15 has a reception unit 15A, a determination unit 15B, a calculation unit 15C, and an output unit 15D. The control unit 15 may be implemented by, for example, hard wired logic.

The reception unit 15A is a processing unit that receives various types of information. The reception unit 15A corresponds to an example of a first reception unit, a second reception unit, and a third reception unit. In one embodiment, the reception unit 15A receives data, such as amounts of power generated, setting information, amounts of power used, and manufacturing process information, via the various systems 3, various devices 5, or user terminal 30.

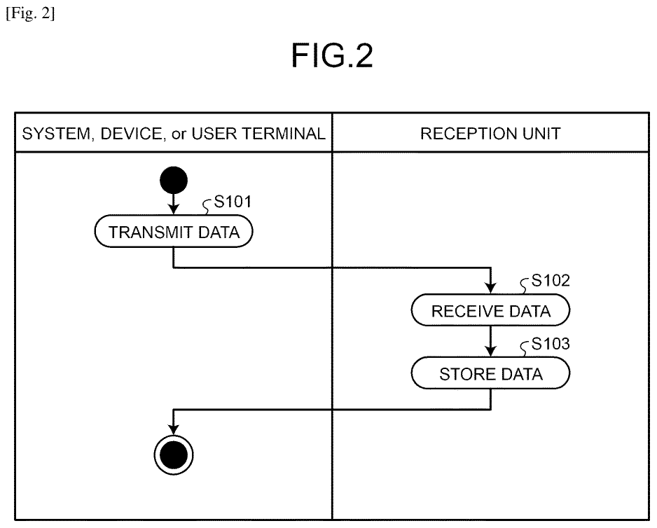

FIG. 2 is a flowchart illustrating steps of a data reception process. As illustrated in FIG. 2, the various systems 3, the various devices 5, or the user terminal 30 transmit/transmits data, such as amounts of power generated, setting information, amounts of power used, or manufacturing process information (Step S101).

In response to such transmission of data, the reception unit 15A receives the data, such as the amounts of power generated, the setting information, the amounts of power used, or the manufacturing process information, via the network NW (Step S102).

The reception unit 15A then registers the data, such as the amounts of power generated, the setting information, the amounts of power used, or the manufacturing process information, as the amounts of power supplied 13A, the setting information 13B, the amounts of power used 13C, or the manufacturing process information 13D, into the storage unit 13 (Step S103). The amounts of power supplied 13A, the setting information 13B, the amounts of power used 13C, and the manufacturing process information 13D may be stored in the storage unit 13 as a relational database or in any data format.

In one aspect, the reception unit 15A may receive a supplied amount of energy supplied to a user from a power generator at Step S102 above to implement electric power tracking.

“Electric power tracking” referred to herein means certifying that electricity consumed by a user is derived from a specific power generation source. However, derivation of a power generation source of electricity flowing in an electric power system (power transmission and distribution network) is assumed to be physically unidentifiable, and physical identification and tracking of the electricity flowing in the electric power system are thus not performed.

According to the basic idea of this tracking, when it can be confirmed that the amount of power generated by a power source connected to an electric power system is equal to the amount consumed by a user facility connected to the same electric power system (electric power is balanced) and electricity generated by the power source is not consumed by another, the electricity derived from that specific power source is assumed to have been consumed by that specific user.

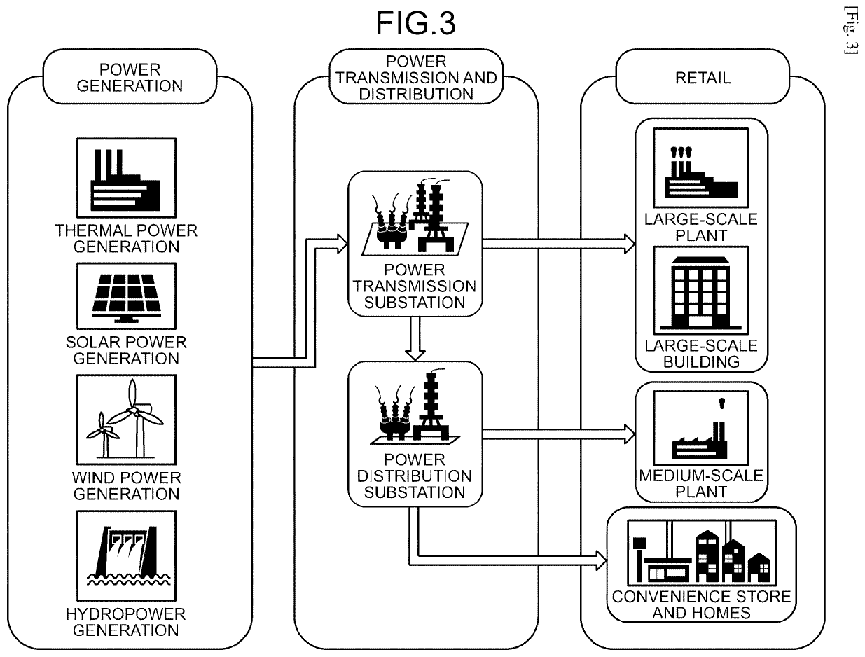

Supply of energy to a user from a power generator may be implemented in the following mode. A “power generator” referred to herein corresponds to an example of a supplier having a power generation facility that generates electric power including clean energy and/or fossil energy. Furthermore, a “user” corresponds to an example of a consumer who has a demand facility that receives and consumes supply of electric power. Such power generators and users may be business operators, such as individuals and corporations, and may also be local and national public organizations. In a first case described herein, a combination of a specific user and a specific power generation source has been defined beforehand. FIG. 3 is a schematic diagram illustrating an electric power supply system. As illustrated in FIG. 3, the electric power supply system may be divided into a power generation sector, a power transmission and distribution sector, and a retail sector. For example, the power generation sector includes thermal power generation serving as a power generation source using fossil energy and power generation sources that use renewable energy, such as solar power generation, wind power generation, and hydropower generation. Furthermore, the power transmission and distribution sector has a power transmission and distribution network formed therein, the power transmission and distribution network connecting users and power generation stations to each other. The power transmission and distribution network may include: a power transmission line that connects a power generation station and a power transmission substation to each other, the power transmission substation being, for example, an extra high-voltage substation, a primary substation, or a secondary substation; and a power distribution line that connects a power distribution substation and a general user to each other. Furthermore, the retail sector may include: a user, such as a large-scale plant or large-scale building that receives supply of special high voltage power; a user, such as a medium-scale plant that receives supply of high voltage power; and a general user that receives supply of low voltage power.

For example, in an example of power balancing in the above mentioned electric power supply system, when solar power generation generates electricity of 1 kWh and a user who has contracted with this solar power generation company consumes electricity of 1 kWh at the same time, it is assumed that “this 1 kWh is the electricity from the solar power generation”. Without being limited to solar power generation, no matter what the type of power generation source the contracted electric power company has is, the same power transmission and distribution line is used for the supply of electric power, and matching the electric power company (supplier) and the user (demander) thus achieves power balancing.

In such an electric power supply system, electric power is supplied on the basis of a contract signed between a power generation operator and a user. Therefore, by receiving pieces of contract information that is information on a contract signed between a power generation operator and a user organization from the user terminal 30, for example, the reception unit 15A is able to obtain, as amounts of supply of energy to the user organization, amounts of power defined by the contract information. An “amount of supply” referred to herein may correspond to an interval standardly used in power balancing, for example, 30 minutes. Obtaining amounts of supply respectively for pieces of contract information thus enables amounts of supply to be obtained respectively for different types of energy of power generation sources that a power generation operator has. For example, without being limited to classifications, such as fossil energy and renewable energy, amounts of supply may be obtained respectively for different types of renewable energy, such as sunlight energy, wind energy, hydro-energy, geothermal energy, solar thermal energy, and biomass energy. Without being limited to automatic extraction from contract information, an amount of supply of energy to a user organization may be input via a graphical user interface (GUI).

In a second case described herein, a certificate representing an attribute value separated from electricity after power generation is issued and a determination is made for the first time through purchase of the certificate. Representative examples of the attribute value include an environmental value. Environmental values may include “green power certificates”, “J-Credits”, and “non-fossil certificates”. Among these, a green power certificate is a certificate certifying an “environmental value” by dividing the value of electricity of renewable energy into a “value of electricity itself” and an “environmental value”.

FIG. 4 is a schematic diagram illustrating an example of purchase of a certificate. As illustrated in FIG. 4, at the time of bidding for a non-fossil certificate, an amount of purchase (offset) for the non-fossil certificate is calculated from an amount of power used by a user. For example, the offset may be an amount of purchase corresponding to an amount of power lacking for RE100. In response to such determination of an amount of purchase, a bid is made for purchase by a purchaser, such as a user, in a power transaction system, the bid specifying a range of frames and an amount of purchase that the user desires to purchase from 48 frames corresponding to one day, with 50 kWh per frame (30 minutes) being the minimum transaction unit. A bid is also made for sale by a seller, such as a power generation operator A or a power generation operator B, in the power transaction system, the bid specifying a range of frames and an amount of sale that the power generation operator A or B desires to sell. In such bidding, bids for “sale” and “purchase” are matched and the contracted price and contracted amount are determined by the power transaction system, a transaction is thereby implemented, and a non-fossil certificate is procured as a result. An example where a user makes a bid in a power transaction system has been described above, but an agent that performs management of environmental values on behalf of a user may of course make a bid in a power transaction system.

For example, in an example supposed herein, the example being an example of power balancing in the above described purchase of a certificate, solar power generation is installed in a plant A and is self-consumed by the plant A. In a case where an environmental value of “no carbon dioxide emission” is unnecessary for the plant A, this environmental value can be sold as a “green power certificate”. In a case where this certificate has been purchased by another plant B, the plant B is assumed to have used renewable energy therein and reduced emission of carbon dioxide.

In such purchase of a certificate, a non-fossil certificate is procured via a power transaction system. Therefore, the reception unit 15A receives an amount of purchase for the non-fossil certificate from the power transaction system, which is an example of one of the various systems 3. For example, the various systems 3 enable obtainment of amounts of purchase for such non-fossil certificates as amounts of supply of renewable energy to user organizations. Amounts of supply can of course be obtained respectively for different types of renewable energy, such as sunlight energy, wind energy, hydro-energy, geothermal energy, solar thermal energy, and biomass energy.

In another aspect, the reception unit 15A may receive setting information on a user from the user terminal at Step S102 described above.

For example, the setting information may include settings for types of energy, CO2 emission factors, and renewable energy factors, of respective power generators. Among these, a “CO2 emission factor” is an index indicating how much CO2 is emitted for supply of electricity of 1 kWh. For example, a CO2 emission factor (kg-CO2/kWh) is calculated by dividing an amount of CO2 emitted by an amount of power sold. Furthermore, a “renewable energy factor” is an index indicating a level, at which energy generated by a power generator corresponds to clean energy. For example, a renewable energy factor may be a value normalized in a numerical range of 0 to 1. In this case, the closer the renewable energy factor is to 1, the closer the energy is to completely clean energy, and the closer the renewable energy factor is to 0, the closer the energy is to pure fossil energy. Such a renewable energy factor may be set collectively or for each time period.

Furthermore, the setting information may include settings for degrees of priority of allocated targets, such as products, manufacturing processes, manufacturing lines, or manufacturing plants. For example, in an example where the allocated targets are manufacturing lines A to Z, degrees of priority are set for the manufacturing lines A to Z in ascending or descending order of priority. The setting information may also include settings for degrees of priority among facilities that a user organization has. For example, a first degree of priority may be set for a plant A, a second degree of priority may be set for a plant B, and a third degree of priority may be set for an office. In this case, electric power is allocated according to the order of priority from the plant A, to the plant B, and then to the office. Furthermore, the setting information may include settings of degrees of priority for power generators allocated to allocated targets or types of energy generated by a power generator. For example, a first degree of priority may be set for wind power energy, a second degree of priority may be set for sunlight energy, and a third degree of priority may be set for fossil energy. In this case, electric power is allocated according to the order of priority from the wind power energy, to the sunlight energy, and then to the fossil energy. The degrees of priority for the allocated targets, facilities, and types of energy, for example, may be set collectively or for each time period.

The setting information may also include a setting for a power balancing interval. For example, in addition to 30 minutes that is standardly set, any interval, for example, 15 minutes or 60 minutes, may be set as the power balancing interval.

In yet another aspect, the reception unit 15A may receive amounts of energy used by a user organization from the various devices 5 at Step S102 described above. For example, the reception unit 15A may receive amounts of electric power used, the amounts having been respectively measured by smart meters connected to demand facilities that the user organization has, the smart meters being an example of the various devices 5. In general, a so-called 30-minute demand value that is an average value of electric power consumed in a 30-minute interval regarded as a standard interval for power balancing is read from a smart meter. A target, for which a reading is to be taken from a smart meter, may be any unit in a facility that the user organization has, for example, a unit, such as a product, a manufacturing process, a device that implements a manufacturing line, or the whole plant. An example where amounts of energy used are received from smart meters has been described above, but input of an amount of energy used may be received from the user terminal 30 via a GUI. In this case, the reception unit 15A may cause amounts of energy used in a predetermined time period, for example, one day or one week, to be input collectively.

In another aspect, the reception unit 15A may receive manufacturing process information on a product from a manufacturing management system corresponding to one of the various systems 3 at Step S102 described above. A “manufacturing management system” referred to herein is a system that manages manufacture of a product and includes, as one function thereof, a function for registration or update of manufacturing process information. For example, the manufacturing process information may be data having products included in a manufacturing plan, the products having been respectively associated with manufacturing time periods, in which manufacturing plants, manufacturing lines, or manufacturing apparatuses included in a manufacturing line are used, for example, start times of use and finish times of use. Furthermore, the manufacturing process information may be data having manufacturing processes of products, the manufacturing processes having been respectively associated with manufacturing time periods, in which manufacturing plants, manufacturing lines, or manufacturing apparatuses are used in the manufacturing processes, for example, start times of use and finish times of use. The manufacturing process information may also optionally include renewable energy ratios and amounts of CO2 emitted, for parts and materials used in manufacture. An example where manufacturing process information is received from a manufacturing management system has been described above but manufacturing process information may be received from the user terminal 30 via a GUI. In this case, the reception unit 15A may cause manufacturing process information to be collectively input, the manufacturing process information being on a product and corresponding to a predetermined time period, for example, one day or one week.

The determination unit 15B is a processing unit that determines allocated amounts of clean energy to be allocated to allocated targets by comparing, in descending order of priority of the allocated targets, amounts of energy used at the allocated targets with a supplied amount of clean energy supplied to an organization as a whole.

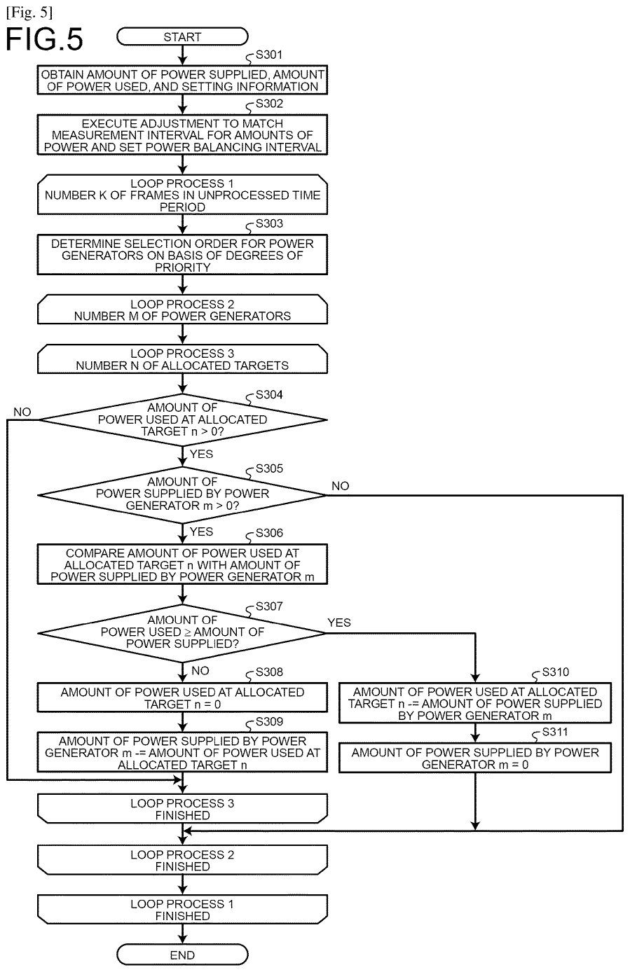

FIG. 5 is a flowchart illustrating steps of an energy allocation process. As illustrated in FIG. 5, the determination unit 15B obtains the amounts of power supplied 13A, the setting information 13B, and the amounts of power used 13C that have been stored in the storage unit 13 (Step S301).

Subsequently, the determination unit 15B executes preprocessing of matching the power balancing interval set in the setting information 13B and the measurement interval for the amounts of power supplied 13A and the amounts of power used 13C (Step S302).

For example, when the measurement interval for the amounts of power supplied 13A and the amounts of power used 13C is 30 minutes and the power balancing interval has been set to one hour, the paired two amounts of power are added up together and the paired two amounts of power used are added up together. Furthermore, when the measurement interval for the amounts of power supplied 13A and the amounts of power used 13C is 30 minutes and the power balancing interval has been set to 15 minutes, the amount of power supplied in 15 minutes and the amount of power used in 15 minutes are calculated by dividing each of the amount of power supplied in 30 minutes and the amount of power used in 30 minutes by the ratio of the power balancing interval, for example, 2.

The determination unit 15B executes a loop process 1 of repeating processing from Step S303 described below to Step S311 described below for a number of times corresponding to the number K of frames in a time period, for which allocation of clean energy has not been processed yet.

That is, on the basis of degrees of priority of power generators set in the setting information 13B, the determination unit 15B determines the order, in which the power generators are selected, the power generators being sources, from which clean energy is to be allocated (Step S303). For example, in a case where degrees of priority have been set for power generators, the degrees of priority being, for example, a first degree of priority set for a power generator A, a second degree of priority set for a power generator C, and a third degree of priority set for a power generator B, the order, in which they are selected, is determined so that the power generator A, the power generator C, and the power generator B are selected in this order. An example where the order, in which power generators are selected, is determined on the basis of degrees of priority of the power generators has been described above, but the order, in which the power generators are selected, may be determined on the basis of degrees of priority of types of energy generated by the power generators.

The determination unit 15B then executes a loop process 2 and a loop process 3 of repeating processing from Step S304 described below to Step S311 described below until selection of M power generators is finished or selection of N allocated targets is finished. An “allocated target” referred to herein may be a product, a manufacturing process, a manufacturing line, or a manufacturing apparatus included in a manufacturing process or manufacturing line.

That is, the determination unit 15B determines whether or not the amount of power used at an allocated target n being selected is larger than “0” (Step S304). In a case where the amount of power used at the allocated target n is not larger than “0” (Step S304: No), allocation of energy to the allocated target n is found to have finished. In this case, processing from Step S305 to Step S309 is skipped, a loop counter n for allocated targets is incremented, and the next allocated target is selected. The order, in which the allocated targets are selected, is also determined on the basis of degrees of priority of the allocated targets, the degrees of priority having been set in the setting information 13B.

On the contrary, in a case where the amount of power used at the allocated target n is larger than “0” (Step S304: Yes), the allocation of energy to the allocated target n is found to have been unfinished. In this case, the determination unit 15B further determines whether or not the amount of power supplied by a power generator m being selected is larger than “0” (Step S305).

In a case where the amount of power supplied by the power generator m is not larger than “0” (Step S305: No), the power generator m is found to have no more remaining electric power to be allocated to the allocated target n. In this case, processing from Step S306 to Step S311 is skipped, a loop counter m for power generators is incremented, and the next power generator is selected.

Furthermore, in a case where the amount of power supplied by the power generator m is larger than “0” (Step S305: Yes), the power generator m is found to have electric power to spare for allocation to the allocated target n. In this case, the determination unit 15B compares the amount of power used at the allocated target n and the amount of power supplied by the power generator m with each other (Step S306).

In a case where the amount of power used at the allocated target n is less than the amount of power supplied by the power generator m (Step S307: No), the remaining amount of power supplied by the power generator m is found to enable allocation of electric power to the allocated target n to be finished. In this case, the determination unit 15B updates the amount of power used at the allocated target n to “0” (Step S308), and updates the amount of power supplied by the power generator m to the latest amount by subtracting the amount of power used at the allocated target n from the amount of power supplied by the power generator m (Step S309). Thereafter, the loop counter n for the allocated targets is incremented and the next allocated target is selected.

Repetition of this loop process 3 results in allocation of the power generators or types of energy to the allocated targets in descending order of priority of the allocated targets and the power generators or types of energy are allocated to each of the allocated targets in descending order of priority of the power generators or types of energy.

Furthermore, in a case where the amount of power used at the allocated target n is equal to or larger than the amount of power supplied by the power generator m (Step S307: Yes), allocation of electric power to the allocated target n is found to not finish even if all of the remaining amount of power supplied by the power generator m is allocated to the allocated target n. In this case, by subtraction of the amount of power supplied by the power generator m from the amount of power used at the allocated target n, the amount of power used at the allocated target n is updated to the latest amount (Step S310), and the amount of power supplied by the power generator m is updated to “0” (Step S311). Thereafter, the loop counter m for the power generators is incremented and the next power generator is selected.

Repetition of this loop process 2 results in allocation of energy to the allocated targets in descending order of priority of the power generators or types of energy, and each of the power generators or types of energy is allocated to the allocated targets in descending order of priority of the allocated targets.

Furthermore, repetition of the loop process 1 results in, for each time period, in which allocation of clean energy has not been processed yet: allocation of the power generators or types of energy to the allocated targets in descending order of priority of the allocated targets, the power generators or types of energy being allocated to each of the allocated targets in descending order of priority of the power generators or types of energy; as well as allocation of energy to the allocation targets in descending order of priority of the power generators or types of energy, each of the power generators or types of energy being allocated to the allocated targets in descending order of priority of the allocated targets.

In the example described with respect to the flowchart illustrated in FIG. 5, the renewable energy ratio targeted is RE100 and clean energy is allocated to the allocated target t, the clean energy corresponding to the amount of power corresponding one-to-one to the total amount of power used at the allocated target n, but the embodiment is not limited to this example. For example, the renewable energy ratio targeted may be any value less than RE100, for example, RE90 or RE80.

The calculation unit 15C illustrated in FIG. 1 is a processing unit that calculates an RE level for an allocated target. An “RE level” referred to herein is a level of renewable energy allocated to an allocated target, the renewable energy being from the amount of power used at the allocated target, and examples of an “RE level” may include a renewable energy ratio and an amount of CO2 emitted.

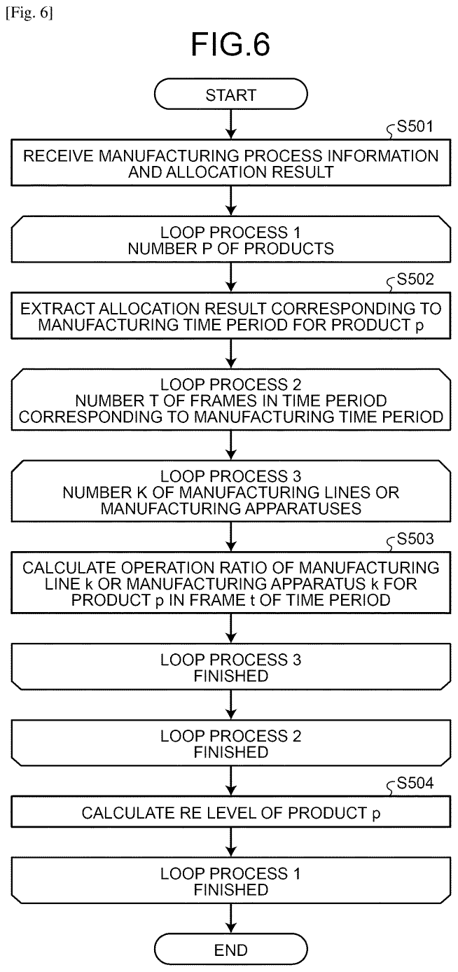

FIG. 6 is a flowchart illustrating steps of an RE level calculation process. As illustrated in FIG. 6, the calculation unit 15C obtains results of allocation by the determination unit 15B and the manufacturing process information 13D stored in the storage unit 13 (Step S501).

The calculation unit 15C then executes a loop process 1 of repeating processing from Step S502 described below to Step S504 described below for a number of times corresponding to the number P of products included in the manufacturing process information 13D.

That is, the calculation unit 15C refers to a manufacturing time period for a product p being selected from the manufacturing process information 13D and extracts a result allocation for a time period from the results of allocation by the determination unit 15B, the time period being overlapped by the manufacturing time period for the product p (Step S502).

The calculation unit 15C then executes a loop process 2 of repeating processing of Step S503 described below for a number of times corresponding to the number T of frames in the time period corresponding to the manufacturing time period for the product p. Furthermore, the loop process 2 includes a loop process 3 of repeating the processing of Step S503 described below for the number K of manufacturing lines or manufacturing apparatuses for the product p, the manufacturing lines or manufacturing apparatuses operating in a time period t being selected. That is, the calculation unit 15C calculates an operation ratio of a manufacturing line k for the product p in the time period t or an operation ratio of a manufacturing apparatus k for the product p in the time period t, on the basis of a time period overlapped by the manufacturing time period for the product p, the time period being in the time period t being selected, that is, on the basis of an actual operating time period of the manufacturing line k for the product p or an actual operating time period of the manufacturing apparatus k for the product p (Step S503). For example, an operation ratio is able to be calculated by normalization of an actual operating time period in the time period t to an actual operating time period per unit time. In a calculation example, when the time period t has a frame size of 30 minutes, the unit time is one hour, and the actual operating time period is ten minutes, the actual operating time period per hour is found to be “20 minutes” by calculation of 10 minutes×(60 minutes/30 minutes) and the operation ratio is found to be “⅓” by dividing this “20 minutes” by the unit time.

Repetition of the loop process 3 results in calculation of the operation ratio for each manufacturing line k or manufacturing apparatus k for the product p in the time period t being selected. Furthermore, repetition of the loop process 2 results in calculation of the operation ratios for K manufacturing lines for the product p or the operation ratios for the K manufacturing apparatuses for the product p, for each time period t overlapped by the manufacturing time period for the product p.

Thereafter, the calculation unit 15C calculates an RE level for the product p (Step S504). For example, in a case where a renewable energy ratio is calculated as an example of the RE level, the calculation unit 15C is able to calculate the renewable energy ratio for the product p according to Equation (1) below. “RE level of manufacturing line k or manufacturing apparatus k in time period t” in Equation (1) below is able to be calculated according to Equation (2) below. In Equation (1) and Equation (2) below, “i” is the number of power generators allocated to the manufacturing line k or manufacturing apparatus k.

$$Re newable energy ratio = Σ ( RE level of manufacturing line k or manufacturing \\ apparatus k in time period t \times opration ratio ) / Σ ( operation ratio ) \qquad ( 1 )$$

$$RE level of manufacturing line k or \\ manufacturing apparatus k in time period t = Σ ( allocated amount it \times renewable energy index i of allocated electric power ) / \\ Σ ( amount kt of electric power used ) \qquad ( 2 )$$

Furthermore, in a case where an amount of CO2 emitted is calculated as an example of the RE level, the calculation unit 15C is able to calculate the amount of CO2 emitted for the product p, according to Equation (3) below. “Amount of CO2 emitted by manufacturing line k or manufacturing apparatus k in time period t” in Equation (3) below is able to be calculated according to Equation (4) below.

$$Amount of CO2 emitted = Σ ( amount of CO2 emitted by manufacturing line k or \\ manufacturing apparatus k in time period t \times operation ratio ) + Σ ( amount of CO2 emitted by material used in \\ manufacturing line k or manufacturing apparatus k ) \qquad ( 3 )$$

$$Amount of CO2 emitted by manufacturing line k or \\ manufacturing apparatus k in time period t = Σ ( allocated amount it \times CO2 emission factor i of allocated electric power ) \qquad ( 4 )$$

Repetition of this loop process 1 results in calculation of an RE level for each of P products, for example, a renewable energy ratio or an amount of CO2 emitted. FIG. 6 illustrates an example where RE levels are calculated in units of products, but RE levels may be calculated in units of manufacturing processes, units of manufacturing lines, or units of manufacturing plants.

Results of calculation of RE levels thus calculated in units of products or units of manufacturing processes may be stored in the storage unit 13. The results of the calculation of the RE levels are not necessarily stored in a relational database. For example, the results of the calculation of the RE levels may be recorded in a blockchain network.

Blockchain technology is one of distributed ledger technologies that allow plural nodes of a peer to peer (P2P) network to hold the same database. A group of transactions on a P2P network are collectively processed as a block in a blockchain and blocks are linked to each other by hash functions. Data in a block recorded in a blockchain cannot be altered retroactively unless all of its subsequent blocks are altered and ledger management platformed using blockchains are thus highly secure against alteration.

Any method, such as Proof of Work (PoW) or Proof of Stake (POS), may be used as a consensus algorithm used between nodes forming such a blockchain network.

An electronic signature using a secret key is assigned to transaction data in a blockchain and impersonation is thereby prevented. A public key cryptosystem is not necessarily used in encryption of the transaction data. For example, any encryption algorithm, such as Advanced Encryption Standard (AES), Secure Hash Algorithm (SHA), Rivest-Shamir-Adleman cryptosystem (RSA), or Elliptic Curve Cryptography (ECC), may be used.

Furthermore, data on each transaction are made public and shared throughout the blockchain network. For some types of P2P databases, the same records are not necessarily held throughout the P2P networks.

Any method, such as Proof of Work (PoW) or Proof of Stake (POS), may be used as a consensus algorithm used between nodes forming such a blockchain network.

In a case where results of calculation of RE levels are thus recorded in a blockchain network, the determination unit 15B generates transaction data corresponding to a result of calculation of an RE level in a frame of one time period, transmits a request to the blockchain network, the request being for registration of the transaction data, and thereby enables the result of the calculation of the RE level to be recorded in a blockchain.

The output unit 15D illustrated in FIG. 1 is a processing unit that outputs various types of information. In one aspect, the output unit 15D may output an RE level calculated for each product to any output destination including the user terminal 30. An output destination referred to herein may include: an application or a service executed by a computer of a user organization; or a computer of a third party other than the user organization, for example, a client for a product, or an application or a service executed by that computer.

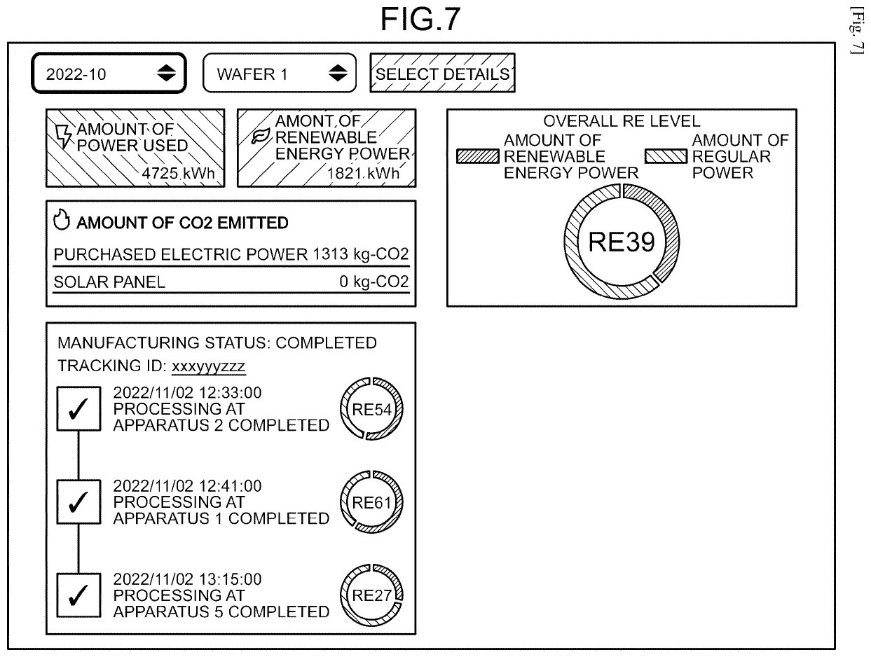

FIG. 7 is a diagram illustrating an example of display at the user terminal 30. FIG. 7 illustrates an example where an RE level of an example of a product, “wafer 1”, is displayed. In the example illustrated in FIG. 7, the amount of power of renewable energy in the amount of power, “4725 kWh”, used for the product, “wafer 1”, is “1821 kWh”. Furthermore, in the amount of CO2 emitted for the product, “wafer 1”: the amount of CO2 emitted resulting from electric power purchased is 1313 kg-CO2; and the amount of CO2 emitted originating from a solar panel is 0 kg-CO2. Furthermore, RE levels are respectively displayed for manufacturing processes of the product, “wafer 1”. That is, among the manufacturing processes of the product, “wafer 1”, the renewable energy ratio of a manufacturing process using a manufacturing apparatus 2 is “54%”, the renewable energy ratio of a manufacturing process using a manufacturing apparatus 1 is “61%”, and the renewable energy ratio of a manufacturing process using a various device 5 is “27%”. The overall renewable energy ratio in all of the manufacturing processes of the product, “wafer 1”, is “39% (=1821 kWh/4725 kWh)×100”.

Such display enables evaluation of RE levels in product units and manufacturing process units that are smaller than the whole organization. The fact that the user organization is promoting introduction of renewable energy to its business operations is thereby able to be certified. Furthermore, promoting measures for a social goal, such as decarbonization, leads to improvement of the corporate value. Furthermore, a share of renewable energy related to manufacture itself of each product is able to be known in procurement of electric power, how much more is needed for achievement of RE100 is thus visualized, and efficient investment in renewable energy is thus enabled. For example, in the example illustrated in FIG. 7, electric power tracking for the product, “wafer 1”, informs that an environmental value corresponding to 2904 kWh needs to be purchased for adaptation to RE100.

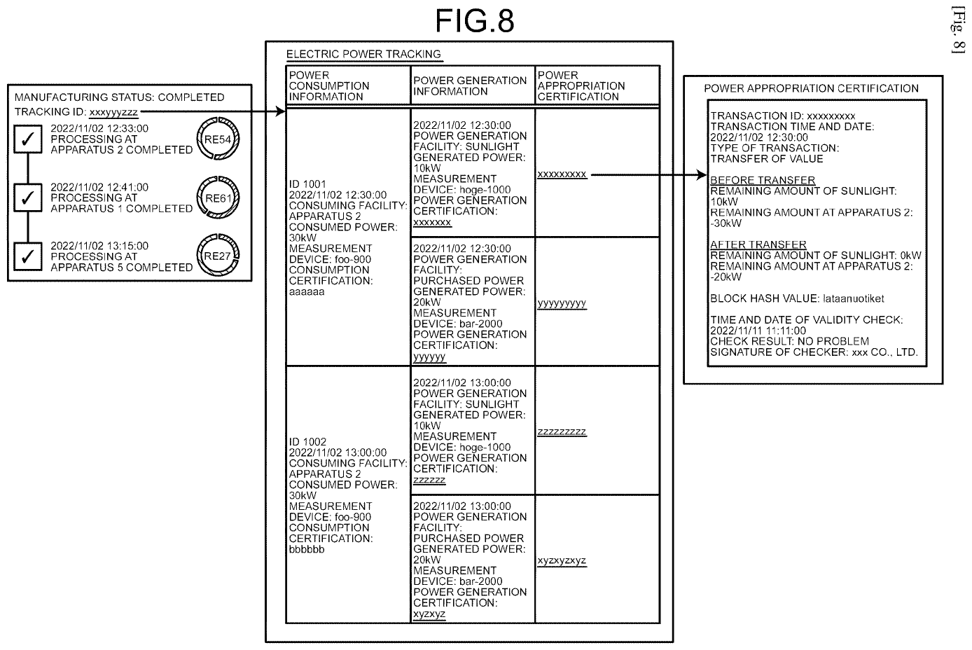

In another aspect, the output unit 15D may issue a certificate certifying an RE level of a product. FIG. 8 is a diagram illustrating an example of display at the user terminal 30. FIG. 8 illustrates a certificate corresponding to results of electric power tracking for the product, “wafer 1”, illustrated in FIG. 7. For example, operation on a link to a tracking ID, “xxxyyyzzz”, which is an example of identification information on the electric power tracking for the product, “wafer 1”, results in display of, as the results of the electric power tracking for the product, “wafer 1”: detailed information on amounts of power used at the manufacturing apparatus 2 that manufactures the product, “wafer 1”, and detailed information including allocated amounts of renewable energy allocated to the manufacturing apparatus 2 that manufactures the product, “wafer 1”. Power appropriation certification is thus able to be output for each type of renewable energy allocated. For example, FIG. 8 illustrates power appropriation certification for sunlight allocated to amounts of electric power used at the manufacturing apparatus 2 that manufactures the product, “wafer 1”. That is, the power appropriation certification may include detailed information on transactions performed in the power transaction system, remaining amount information on sunlight before and after a transfer, the remaining amount information corresponding to a supplier, from which the user organization has purchased an environmental value in the power transaction system, and a hash value of a block having results recorded therein, the results being those of allocation of sunlight.

### One Aspect of Effects

As described above, the energy management system 1 according to the embodiment allocates clean energy to targets smaller than the whole organization in electric power tracking, the targets being, for example, products or manufacturing processes, the clean energy having been supplied to the whole organization according to amounts of energy used at the targets. Therefore, the energy management system 1 according to the embodiment enables evaluation of levels of clean energy in smaller units than the whole organization. Furthermore, allocated amounts are determined in descending order of priority of allocated targets in the allocation and the amount of calculation by the information processing apparatus 10 is thus able to be reduced because allocation to the allocated targets lower in priority may be not necessarily determined.

### Numerical Values

The particulars described above with respect to the embodiment, for example, the types of energy, the number of power generators, the example of display of the RE levels, and the specific example of the certificate of the electric power tracking, are just examples and may be modified. Furthermore, the order of the steps in the flowcharts described with respect to the embodiment may be modified so long as no contradiction is caused by the modification.

### System

The processing steps, control steps, specific names, and information including various data and parameters, which have been described above and illustrated in the drawings may be optionally modified unless particularly stated otherwise. For example, any one or more functional units of the reception unit 15A, the determination unit 15B, the calculation unit 15C, and the output unit 15D may be included in different devices.

Furthermore, the components of each apparatus/device in the drawings have been illustrated functionally and/or conceptually, and do not need to be physically configured as illustrated in the drawings. That is, specific modes of separation and integration of each apparatus/device are not limited to those illustrated in the drawings. That is, all or part of each apparatus/device may be configured by functional or physical separation or integration thereof in any units according to various loads and/or use situations. Each configuration may also be a physical configuration.

Furthermore, all or any part of the processing functions performed in each apparatus/device may be implemented by a central processing unit (CPU) and a program analyzed and executed by the CPU, or may be implemented as hardware by wired logic.

### Hardware

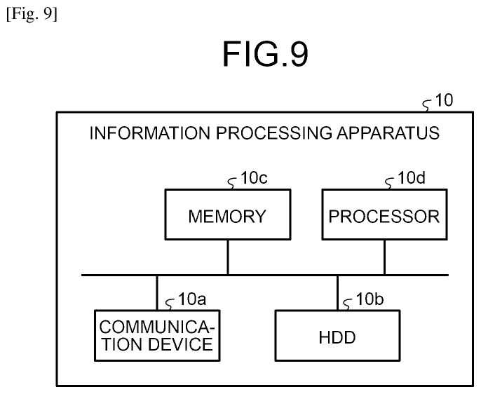

An example of a hardware configuration of a computer described with respect to the embodiment will be described next. FIG. 9 is a diagram illustrating the example of the hardware configuration. As illustrated in FIG. 9, the information processing apparatus 10 has a communication device 10a, a hard disk drive (HDD) 10b, a memory 10c, and a processor 10d. Furthermore, these units illustrated in FIG. 9 are connected to one another via a bus, for example.

The communication device 10a is a network interface card, for example, and performs communication with another server. The HDD 10b stores a program that causes the functions illustrated in FIG. 1 to operate and a DB, for example.

The processor 10d causes a process to be operated, the process executing the functions described by reference to FIG. 1, for example, by reading, from the HDD 10b, for example, the program that executes processing similar to that by the processing units illustrated in FIG. 1, and loading the program into the memory 10c. For example, this process executes functions similar to those of the processing units that the information processing apparatus 10 has. Specifically, the processor 10d reads the program having functions similar to those of the reception unit 15A, the determination unit 15B, the calculation unit 15C, and the output unit 15D, from the HDD 10b, for example. The processor 10d then executes the process that executes processing similar to that by the reception unit 15A, the determination unit 15B, the calculation unit 15C, and the output unit 15D, for example.

The information processing apparatus 10 thus operates as an information processing apparatus that executes an energy management method, by reading and executing the program. Furthermore, the information processing apparatus 10 may implement functions similar to those according to the above described embodiment by reading the program from a recording medium by means of a medium reading device, and executing the program read. The program referred to herein is not limited to being executed by the information processing apparatus 10. For example, the present invention may be similarly applied to a case where another computer or server executes the program, or a case where the computer and the server execute the program in corporation with each other.

The program may be distributed via a network, such as the Internet. Furthermore, the program may be recorded in any recording medium and executed by being read by a computer from the recording medium. For example, the recording medium may be implemented by a hard disk, a flexible disk (FD), a CD-ROM, a magneto-optical disk (MO), or a digital versatile disc (DVD).

### Others

The following are some examples of a combination of technical features disclosed herein.

(1)

An energy management system comprising:
a first reception unit configured to receive an amount of clean energy obtained;
a second reception unit configured to receive an amount of energy used;
a third reception unit configured to receive a setting of a degree of priority for an allocated target where the amount of clean energy obtained is to be allocated; and
a determination unit configured to determine, by comparing the amount of clean energy obtained with the amount of energy used at the allocated target, an amount of clean energy allocated to the allocated target on the basis of the degree of priority.
   (2)

The energy management system according to (1), wherein
the first reception unit receives the amount of clean energy obtained for each of types of clean energy,
the third reception unit receives the setting of the degree of priority for each of the types and each of time periods, and
the determination unit determines the amount of clean energy allocated, for each of the types and each of the time periods.
   (3)

The energy management system according to (2), further comprising a calculation unit that calculates an amount of carbon dioxide emitted, on the basis of a factor indicating an emitted amount of carbon dioxide emitted in production of each of the types of clean energy and the amount of clean energy allocated.

(4)

The energy management system according to any one of (1) to (3), wherein
the first reception unit receives an amount of non-clean energy obtained, and
the determination unit determines, by comparing the amount of non-clean energy obtained with the amount of energy used, an amount of non-clean energy allocated to the allocated target.
   (5)

The energy management system according to any one of (1) to (4), wherein the determination unit allocates the amount of clean energy obtained, to the allocated target, with the amount of energy used at the allocated target being the upper limit of allocation.

(6)

The energy management system according to any one of (1) to (5), wherein the allocated target corresponds to any of a product, a manufacturing process, a manufacturing line, or a manufacturing apparatus included in the manufacturing process or manufacturing line.

(7)

The energy management system according to any one of (1) to (6), wherein the amount of clean energy obtained includes an evaluation value obtained by purchase in a power transaction system for buying and selling transactions of environmental values separated from non-fossil energy.

(8)

An energy management method carried out by a computer, comprising:
receiving an amount of clean energy obtained;
receiving an amount of energy used;
receiving a setting of a degree of priority for an allocated target where the amount of clean energy obtained is to be allocated; and
determining, by comparing the amount of clean energy obtained with the amount of energy used at the allocated target, an amount of clean energy allocated to the allocated target on the basis of the degree of priority.
   (9)

An energy management program that causes a computer to execute a process comprising:
receiving an amount of clean energy obtained;
receiving an amount of energy used;
receiving a setting of a degree of priority for an allocated target where the amount of clean energy obtained is to be allocated; and
determining, by comparing the amount of clean energy obtained with the amount of energy used at the allocated target, an amount of clean energy allocated to the allocated target on the basis of the degree of priority.

### REFERENCE SIGNS LIST

1 Energy management system
3 Various systems
5 Various devices
10 Information processing apparatus
11 Communication control unit
13 Storage unit
13A Amount of power supplied
13B Setting information
13C Amount of power used
13D Manufacturing process information
15 Control unit
15A Reception unit
15B Determination unit
15C Calculation unit
15D Output unit
30 User terminal

1. An energy management system comprising:
an information processing apparatus including:
a processor configured to:
receive an amount of clean energy obtained;
receive an amount of energy used;
receive a setting of a degree of priority for an allocated target where the amount of clean energy obtained is to be allocated; and
determine, by comparing the amount of clean energy obtained with the amount of energy used at the allocated target, an amount of clean energy allocated to the allocated target on the basis of the degree of priority.

2. The energy management system according to claim 1, wherein the processor is further configured to:
receive the amount of clean energy obtained for each of types of clean energy;
receive the setting of the degree of priority for each of the types and each of time periods; and
determine the amount of clean energy allocated, for each of the types and each of the time periods.

3. The energy management system according to claim 2, wherein the processor is further configured to calculate an amount of carbon dioxide emitted, on the basis of a factor indicating an emitted amount of carbon dioxide emitted in production of each of the types of clean energy and the amount of clean energy allocated.

4. The energy management system according to claim 1, wherein the processor is further configured to:
receive an amount of non-clean energy obtained; and
determine, by comparing the amount of non-clean energy obtained with the amount of energy used, an amount of non-clean energy allocated to the allocated target.

5. The energy management system according to claim 1, wherein the processor is further configured to allocate the amount of clean energy obtained, to the allocated target, with the amount of energy used at the allocated target being the upper limit of allocation.

6. The energy management system according to claim 1, wherein the allocated target corresponds to any of a product, a manufacturing process, a manufacturing line, or a manufacturing apparatus included in the manufacturing process or manufacturing line.

7. The energy management system according to claim 1, wherein the amount of clean energy obtained includes an evaluation value obtained by purchase in a power transaction system for buying and selling transactions of environmental values separated from non-fossil energy.

8. An energy management method comprising:
receiving an amount of clean energy obtained;
receiving an amount of energy used;
receiving a setting of a degree of priority for an allocated target where the amount of clean energy obtained is to be allocated; and
determining, by comparing the amount of clean energy obtained with the amount of energy used at the allocated target, an amount of clean energy allocated to the allocated target on the basis of the degree of priority, using a processor.

9. A non-transitory computer-readable recording medium having stored therein an energy management program that causes a computer to execute a process comprising:
receiving an amount of clean energy obtained;
receiving an amount of energy used;
receiving a setting of a degree of priority for an allocated target where the amount of clean energy obtained is to be allocated; and
determining, by comparing the amount of clean energy obtained with the amount of energy used at the allocated target, an amount of clean energy allocated to the allocated target on the basis of the degree of priority.

10. The energy management system according to claim 2, wherein the processor is further configured to:
receive an amount of non-clean energy obtained; and
determine, by comparing the amount of non-clean energy obtained with the amount of energy used, an amount of non-clean energy allocated to the allocated target.

11. The energy management system according to claim 3, wherein the processor is further configured to:
receive an amount of non-clean energy obtained; and
determine, by comparing the amount of non-clean energy obtained with the amount of energy used, an amount of non-clean energy allocated to the allocated target.
